(19) United States
(12) Patent Application Publication
(10) Pub. No.: US 2002/0084368 A1
(43) Pub. Date: Jul. 4, 2002

(54) Safety systems for grinding machines

(76) Inventors: Jurgen Bernhardt, Biedenkopf-Weifenbach (DE); Hartmut Hoffman, Bad Laasphe-Feudingen (DE)

Correspondence Address: OPPEDAHL AND LARSON LLP, P O BOX 5068, DILLON, CO, 80435-5068, US

(21) Appl. No.: 10/001,513

(22) Filed: Oct. 31, 2001

(30) Foreign Application Priority Data
Oct. 31, 2000 (DE) 100 54 028.7

(51) Int. Cl. A47J 17/14

(52) U.S. Cl. 241/82.5

(57) ABSTRACT

The present invention relates to grinding machines, particularly for grinding frozen and fresh meat, with a set of cutters displaying at least one blade.

The present invention relates to grinding machines, particularly for grinding frozen and/or fresh meat, with a set of cutters displaying at least one blade.

Grinding machines are used in a variety of technical fields today. There are multiple possibilities for using these machines, particularly in the processing of meat in fresh or frozen condition. As these machines are usually equipped with a rotating blade running at high speed, these machines have to be equipped with a safety device to prevent injuries to the operator.

As a rule, this safety device is today a hood that is folded in front of the outlet of the set of cutters in order to prevent the operator from reaching into the set of cutters and thus sustaining injuries. However, this safety device has the disadvantage that it offers only inadequate protection, and that visual inspection of the grinding process and of the ground material is only possible within limits.

This therefore gives rise to the object of providing a grinding machine that does not display the disadvantages of the prior art.

According to the invention, the object is solved by a grinding machine, particularly for grinding frozen and fresh meat, with a set of cutters displaying at least one blade, where a safety device is located downstream of the last: blade of the set of cutters in the direction of material flow to prevent the operator from being injured by the blade.

A grinding machine within the meaning of the invention is any grinding machine that displays a set of cutters with at least one blade. According to the invention, a safety device is located downstream of the last blade in this set of cutters.

A safety device is any component that can be integrated into the set of cutters and that permanently prevents the operator from sustaining finger injuries, especially caused by the rotating blades.

The set of cutters preferably consists of at least one rotating blade and an associated perforated plate. Particularly preferably, the set of cutters consists of several blades, each of which interacts with a perforated plate.

In a preferred configuration, the grinding machine can only be put into operation when the safety device is inserted downstream of the last blade. The check for the presence of the safety device can be made electronically or mechanically.

The safety device is preferably a perforated plate with holes displaying a diameter≦6 mm. The perforated plate preferably has a thickness≧5 mm. This perforated plate prevents injuries to the operator's hand, for example.

In a preferred configuration of the grinding machine according to the invention, the thickness of the perforated plate is monitored, making it possible to prevent the perforated plate from becoming so thin in the event of progressing wear that the operator can put a finger through the perforated plate and be injured by the rotating blade. This thickness monitoring can be performed both mechanically and electronically. Preferably, however, it is linked to the operating time of the perforated plate, as a perforated plate has to be re-ground after a certain number of hours of operation, its thickness being reduced correspondingly as a result. Accordingly, the grinding machine according to the invention calculates the operating time of the perforated plate after which its thickness is no longer sufficient to afford adequate protection against injuries to the operator.

In another preferred configuration, the safety device is integrated into the lock nut of the set of cutters. A safety device of this kind can be a perforated plate or, for example, a wire mesh. As this safety device is at a relatively large distance from the last blade or the associated perforated plate, this form of safety device is particularly efficient.

The grinding machine according to the invention has the advantage that the safety device is integrated in the set of cutters, meaning that no additional components need to be mounted on the grinding machine in order to ensure the safety of the operator. The safety devices are components that are easy to manufacture and install, meaning that the grinding machine according to the invention can be manufactured simply and inexpensively. In a preferred configuration, as the machine can only be put into operation when the safety device is inserted, the possibility of the operator being injured by the grinding machine according to the invention is ruled out.

A further object of the present invention is a perforated plate with holes, particularly as part of a set of cutters for a grinding machine for grinding meat and/or other substances of similar consistency, that displays a means on which data can be stored and retrieved that permit unequivocal identification of the perforated plate.

Preferably, the means on which data can be stored and retrieved is a sensor chip which displays a first, scannable data memory with data that are used as actual values for comparison with the data of a second data memory, assigned to the grinding machine, whose data are matched to the perforated plate and serve as target values for a comparison of actual and target values. Preferably, the control system of a grinding machine in which the perforated plate is installed is designed in such a way that it cannot be put into operation if the actual values differ from the target values. In this way, the perforated plate can server as a safety device, because the comparison of the target and actual values is capable of determining whether a perforated plate is fitted downstream of the last blade whose hole diameter is so small, or whose thickness is so great, that the possibility of the operator being injured by the rotating blade can be ruled out. Most particularly, preferably, the perforated plate has holes with a diameter≦6 mm and preferably a thickness of ≧5 mm.

In a preferred configuration of the perforated plate according to the invention, data are stored on the means which, in particular, contain information concerning the size of the hole and, preferably, the thickness of the respective perforated plate.

Also preferably, data relating to the operating time and stress of the perforated plate can additionally be stored on the means. These data can be used for automatic determination of the wear of the perforated plate, so that the grinding machine can no longer be put into operation when a certain degree of wear of the perforated plate has been exceeded, because the perforated plate according to the invention is no longer adequate as a safety device.

Preferably, the means on which data can be stored and retrieved is provided in a sealed cavity in the perforated plate, so that unauthorised persons can neither find nor manipulate it. The arrangement of the means should at all events be selected in such a way that it becomes unserviceable, or is preferably destroyed, upon removal if discovered by chance.

On a grinding machine, the data from the data memory integrated in a perforated plate of this kind can best be scanned if the means is linked in bi-directional, wireless fashion to a transmitter and receiver system, either located on the grinding machine or mobile, which can be connected via an amplifier to the second data memory and/or an electronic machine control system, so that the data stored on the means can be read and modified. It is particularly advantageous if the transmitter and receiver system is provided in the direct vicinity of the perforated plate.

Following corresponding data extraction, transmission, processing and visualisation on a corresponding display, the data memory integrated in the perforated plate according to the invention supplies the data appropriate for identification of the perforated plate, and possibly also the data of a corresponding counterpart, such as a blade, i.e. of the entire system used for grinding. In the same way, the data can be detected by the control system of the grinding machine and observed in that operation of the grinding machine is only permitted if parts appropriate for the function are used.

Monitoring of the ordinary perforated plates for the grinding machine is also far more easily accomplished in accordance with the invention, because the serial number of the perforated plate can now readily be identified from the data available from the integrated data memory and its wear can be monitored for instance by displaying operating times, grinding intervals and similar parameters.

Preferably, the means is a sensor chip, on which data San be reversibly stored and scanned.

The present invention has the advantage that only unequivocally identifiable components are used in the set of cutters, meaning not only that trouble-free operation of the grinding machine is ensured, but also that a perforated plate can be used as a safety device for a set of cutters because the grinding machine can only be put into operation if a highly specific perforated plate with a degree of wear that is not yet excessive has been identified by the grinding machine.

A further object of the present invention is a grinding machine, preferably a meat grinder, which displays the perforated plate according to the invention.

Preferably, the perforated plate according to the invention is located downstream of the last blade in the direction of material flow in this grinding device, so that it can be used as a safety device to prevent injuries to the operator.

A further object of the present invention is a method for securing grinding machines with the perforated plate according to the invention, where data for identifying the perforated plate located downstream of the last blade in the grinding machine in the direction of material flow are retrieved and a check is made of whether the respective perforated plate satisfies the respective safety standards, and where the grinding machine can only be put into operation if the result of this check is positive. The method according to the invention makes it possible to rule out injuries to the operator by a blade in the set of cutters.

In a preferred configuration of the method according to the invention, the operating time and the mechanical stress of the perforated plate rare additionally retrieved, thus checking its wear, and the grinding machine is either not started, or it is shut down, in the event of excessive wear. This configuration of the method according to the invention makes it possible to avoid the operator being endangered by worn safety devices.

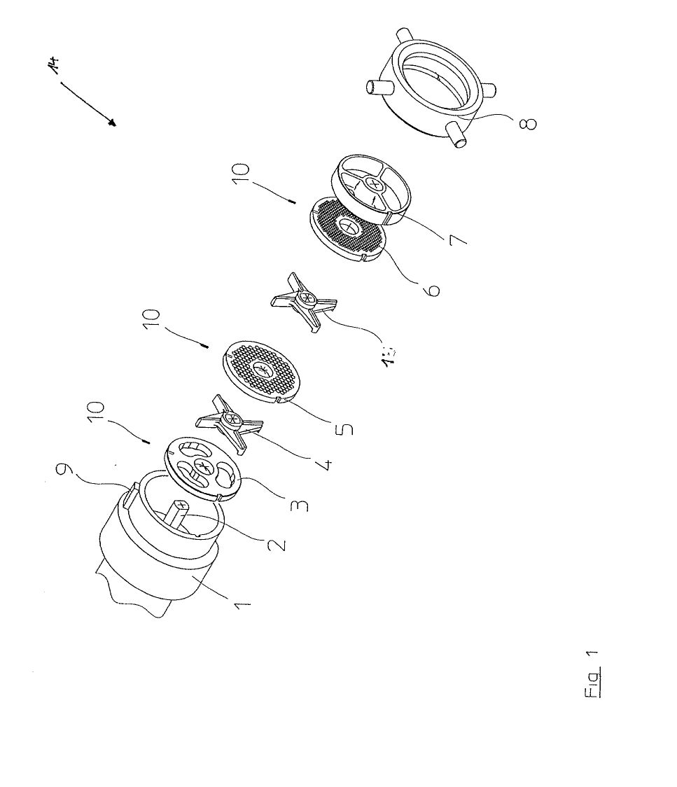

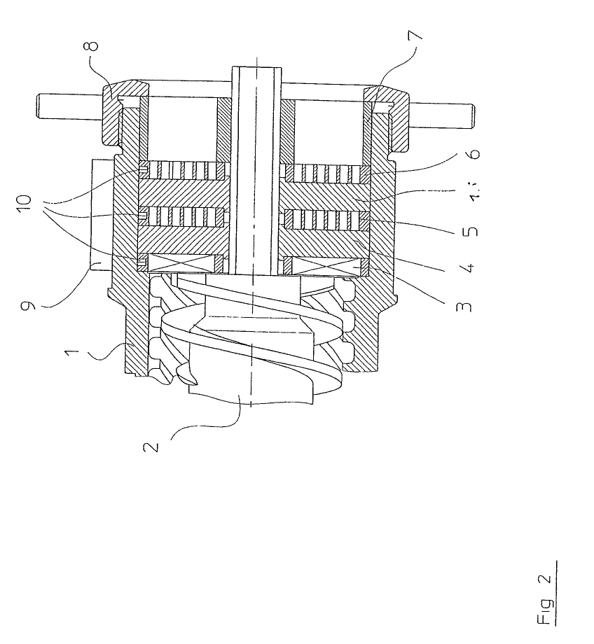

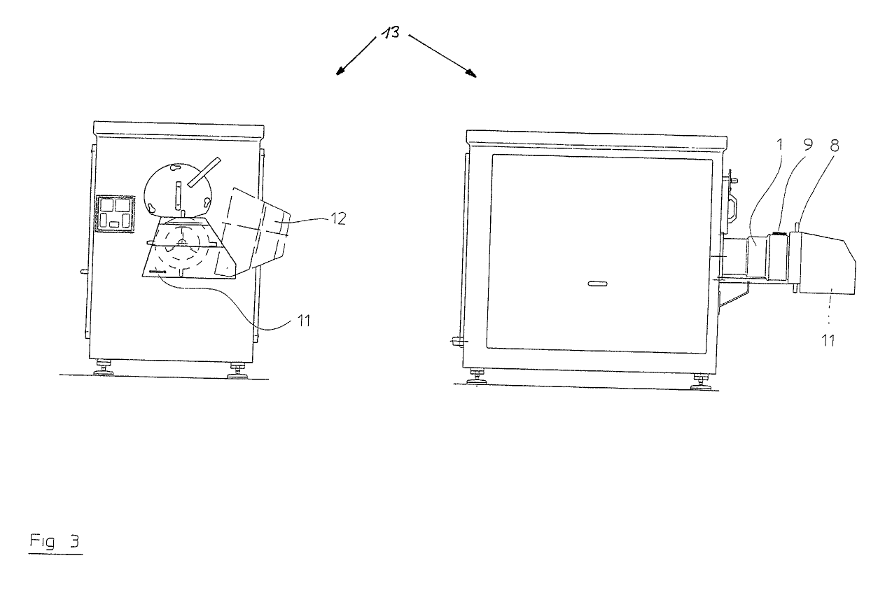

The invention is explained below on the basis of FIGS. 1 and 2. These explanations are merely of an exemplary nature and do not limit the general idea of the invention.

FIG. 1 shows an exploded drawing of the set of cutters of the grinding device according to the invention.

FIG. 2 shows the set of cutters of the grinding machine according to the invention in installed condition.

FIG. 1 shows an exploded drawing of set of cutters 14 of grinding machine 13 according to the invention. The drawing shows only part of housing 1 of grinding machine 13 that accommodates set of cutters 14. The grinding machine according to the invention displays a driven screw with a shaft 2, by means of which blades 4, 15 are caused to rotate. The set of cutters also displays a preliminary cutter 3, two perforated plates 5, 6 and a spacer ring 7. Set of cutters 14 is fixed in place in the housing 1 by means of lock nut 8. The person skilled in the art will recognise that blade 4 interacts with perforated plate 5, and blade 15 with perforated plate 6. Preliminary cutter 3, perforated plates 5, 6 and spacer ring 7 are connected to the housing in non-rotating fashion. Preliminary cutter 3 and perforated plates 5, 6 each display a sensor chip 10, which is located in the outer region of the respective component. These sensor chips interact with transmitter and receiver system 9 in such a way that data can both be scanned from the sensor chips and stored on them. The sensor chip / transmitter-receiver system configuration enables unequivocal identification of the respective components.

According to the invention, the grinding machine displays a safety device downstream of last blade 15 to prevent the operator from being injured by blade 15.

In the present example, this safety device is perforated plate 6, the holes of which have a diameter of 6 mm and which has a thickness of more than 5 mm. The thickness of the perforated plate should not exceed 30 mm. As a result of this design of the perforated plate, it is impossible, for example, for the operator to injure his fingers on rotating blade 15. The person skilled in the art will recognise that, for example, it is also possible to provide a perforated plate| in lock nut 8, this representing an especially good safety device because it is at a greater distance from rotating blade 15 than is perforated plate 6, for example. A perforated plate as a safety device in lock nut 8 could have holes larger than 6 mm in diameter and a thickness of less than 5 mm.

FIG. 2 shows the grinding machine according to the invention with set of cutters 14 in installed condition. Screw 2, which displays a drive shaft at its end, conveys the material to be cut, meat in the present case, through preliminary cutter 3 to first blade 4. This blade 4 interacts with perforated plate 5 and grins the meat. Once the meat has been forced through perforated plate 5, it is once again cut and ground by a further blade 15 and a further perforated plate 6. The person skilled in the art will recognise that blade 15 and perforated plate 6 interact. Perforated plate 6 simultaneously acts as a safety device, as its holes are ≦6 mm in diameter and its thickness is more than 5 mm, making it impossible for an operator to put a finger through the perforated plate and be injured by rotating blade 15. Blades 4 and 15 are driven by the shaft of screw 2, while preliminary cutter 31 and perforated plates 5 and 6 are connected to the housing in stationary fashion. The entire set of cutters is tensioned in the housing by means of spacer ring 7 and lock nut 8. Preliminary cutter 3 and perforated plates 5 and 6 display sensor chips 10, Which are linked to transmitter-receiver device 9 in bi-directional, wireless fashion, so that data can be stored on the sensor chips and retrieved. In the present case, the serial number and the operating time are stored on the sensor chip and automatically retrieved at regular intervals by the grinding machine according to the invention and visualised on a display not illustrated in the drawing. Particularly if safety device 6 is absent or of insufficient size, or if the operating time and thus the wear of safety device 6 are too great, the grinding machine according to the invention cannot be started. This permanently prevents injuries to the operator.

1. Grinding machine (13), particularly for grinding frozen and fresh meat, with a set of cutters (14) displaying at least one blade (14, 15), characterised in that the set of cutters (14) displays a safety device downstream of the last blade (15) in the direction of material flow to prevent the operator from being injured by the blade (15).

2. Grinding machine as per claim 1, characterised in that it can only be put into operation when the safety device is inserted.

3. Grinding machine as per claim 1 or 2, characterised in that the safety device is a perforated plate (6) with a hole diameter≦6 mm and preferably a thickness of ≧5 mm.

4. Grinding machine as per claim 3, characterised in that it displays thickness monitoring of the perforated plate (6), which is preferably linked to the operating time of the perforated plate, where the grinding machine can preferably not be put into operation when the preforated plate drops below a minimum thickness as a result of wear.

5. Grinding machine as per claim 1 or 2, characterised in that the safety device is integrated into the lock nut (8).

6. Perforated plate (6) with holes, particularly as part of a set of cutters (14) for a grinding machine (13) for grinding meat and/or other substances of similar consistency, characterised in that it displays a means on which data can be stored and retrieved that permit unequivocal identification of the perforated plate.

7. Perforated plate as per claim 6, characterised in that the identification particularly contains information concerning the size of the holes and, preferably, the thickness of the perforated plate.

8. Perforated plate as per claim 6 or 7, characterised in that additional data, preferably the operating time and stress of the perforated plate, can be stored on the means and retrieved.

9. Perforated plate as per claim 8, characterised in that the operating time and stress of the perforated plate are used to determine its wear.

10. Perforated plate as per one of claims 6 to 9, characterised in that the means is provided in a sealed cavity.

11. Perforated plate as per one of claims 6 to 10, characterised in that the means is linked to a transmitter (9) and receiver (9) system in bi-directional fashion.

12. Perforated plate as per one of claims 6 to 11, characterised in that the means is a sensor chip.

13. Grinding machine, preferably a meat grinder, displaying a perforated plate as per one of claims 6 to 12.

14. Grinding machine as per claim 13, characterised in that the perforated plate (6) is located downstream of the last blade (15) in the direction of material flow.

15. Method for securing grinding machines with a perforated plate according to claims 6 to 12, characterised in that data for identifying the perforated plate (6) located downstream of the last blade (15) in the grinding machine (13) in the direction of material flow are retrieved and a check is made of whether the respective perforated plate (6) satisfies the respective safety standards, and in that the grinding machine can only be put into operation if the result of this check is positive.

16. Method as per claim 15, characterised in that the operating time and mechanical stress of the perforated plate (6) are additionally retrieved and used to check its wear and in that the grinding machine cannot be started in the event of excessive wear.
